(19) United States
(12) Patent Application Publication
(10) Pub. No.: US 2008/0154686 A1
(43) Pub. Date: Jun. 26, 2008

(54) Method for Fractional Sale of Property

(76) Inventor: Robert Keith Vicino, Solana Beach, CA (US)

Correspondence Address: ERIC HANSCOM, 7395 PORTAGE WAY, CARLSBAD, CA, 92011, US

(21) Appl. No.: 11/960,608

(22) Filed: Dec. 19, 2007

Related U.S. Application Data
(60) Provisional application No. 60/875,942, filed on Dec. 20, 2006.

(51) Int. Cl. G06Q 40/00; G06Q 10/00; G06Q 30/00

(52) U.S. Cl. 705/8; 705/1; 705/14; 705/36 R; 705/37; 705/39

(57) ABSTRACT

A method for assisting property owners in selling property for fractional ownership by locating a property that is already listed for sale and is a qualified candidate property, contacting the listing broker or owner about selling the property fractionally, offering the property for sale for fractional ownership concurrently with offering the property for sale for sole ownership, finding fractional buyers collectively willing to purchase the property for more than it could be sold to a single owner, assisting in the preparation and execution of all necessary documents required for the transactions, overseeing the sales transaction, and obtaining a commission or fee on the sale of the property concurrently with or separate from the listing broker. This creates a turnkey service to property owners interested in selling their property for fractional ownership without any added risk and little to no upfront cost to the property owner.

### CROSS REFERENCE TO RELATED APPLICATIONS

This application relates to and claims the benefit of provisional application 60/875,942 filed on Dec. 20, 2006, which is hereinafter incorporated by reference.

### STATEMENT REGARDING FEDERALLY SPONSORED RESEARCH OR DEVELOPMENT

This invention was not federally sponsored.

### BACKGROUND OF THE INVENTION

### Field of the Invention

This invention relates to the general field of methods for selling property, and more specifically toward a method for assisting property owners in selling property for fractional ownership by locating a property that is already listed for sale and is a qualified candidate property, contacting the listing broker or owner about selling the property fractionally, offering the property for sale for fractional ownership concurrently with offering the property for sale for sole ownership, finding fractional buyers collectively willing to purchase the property for more than it could be sold to a single owner, assisting in the preparation and execution of all necessary documents required for the transactions, overseeing the sales transaction, and obtaining a commission or fee on the sale of the property concurrently with or separate from the listing broker. This creates a turnkey service to property owners interested in selling their property for fractional ownership without any added financial risk and little to no upfront cost to the property owner.

Real estate prices continue to rise around the country and around the world. With major ongoing fluctuations in the gold, monetary, and stock markets, many investors view real property as the soundest long-term financial investment strategy. As real estate prices rise, more and more individuals are turning towards co-ownership of property, as the price of desirable real estate and other high-priced property is frequently beyond the comfortable affordability level of many investors. These arrangements are typically known as fractional ownership, where the co-owners of property agree on an allocation of rights to use the property and of responsibilities for their respective costs and expenses associated with the ownership of the property. Through fractional ownership, individuals that intend to use property for just a fraction of the year can purchase more valuable property than they would otherwise be able to obtain on their own. Vacation property and second homes are common examples where fractional ownership may make sense. An individual may wish to have a vacation home to travel to, but will only spend a fraction of the year in that home. Instead of buying the home by himself or herself, the individual can purchase a fraction of the home with other individuals, and share its use throughout the year. Accompanying the ownership is usually a pre-determined usage schedule or system that may assign specific occupancy dates via a set calendar, a rotating calendar giving owners occupancy in every season or every week over a period of time, a rotating priority usage system which provides a tie-breaker rule should more than one fractional owner wish to use the property at the same time, or a first come, first served reservation system.

Fractional ownership of property is not only economically beneficial for a buyer, but also for the seller. Compared to a conventional sale to a single buyer, property sold for fractional ownership is often sold for 1.8 times the underlying value of the property. For example, a home that would normally be sold for $1,000,000 dollars to a single owner, could be sold for as much as $1,800,000 to all of the fractional owners combined. If there were 12 fractional owners, then each owner would get 1/12 of the marked-up price for a 1/12 equity interest in the property, or a legal entity owning the home, coupled with a right to as much as a collective one month's use, of a $1,000,000 home for $150,000. The seller is happy because of the higher sales price and the opportunity to sell his or her home to an alternate market and buyer, versus just to a sole ownership buyer. In this example, the fractional home buyer is happy because he or she has up to one month's use, which is all the use that he or she needs or desires to begin with, of a home that is more than six times what he or she would have paid had he or she purchased the home entirely by himself or herself. Accordingly, the middle class and affluent alike are discovering that fractional ownership is viable and, in many cases, a more desirable alternative than sole ownership. The fractional buyer is one who has always wanted a vacation home and while they may have the means to secure one, the idea of fractional ownership holds interest for them because it feels every bit like a second home with all of the benefits of sole ownership at a fraction of the cost. The idea of having access to literally as much time as one would desire, short of living there full time, and only paying for that portion in which they will typically use the property, is very compelling. Even those who can afford sole ownership see the added benefits of fractional ownership. Fractional buyers are getting more than part time accommodations. They are getting a lifestyle that they otherwise may not be able to afford on their own. They are also getting piece of mind, as a management company typically attends to all of the things it takes to run and maintain a vacation residence thereby allowing the fractional owners to enjoy their vacation home, worry free, while the management company protects the value of their investment. Indeed, with the money they save by investing in a second or vacation home fractionally, buyers can purchase several fractional interests in different desirable locations and spend less money than had they purchased one single property as the sole owner.

However, selling a property for fractional ownership is not as easy as simply offering it for sale fractionally, and the organizational hurdles can be virtually impossible for a private seller to professionally and successfully surmount. There can be significant upfront costs as well as time and risk associated with selling property for fractional ownership. Properties sold for fractional ownership have primarily been larger multi-unit projects, which were developed and sold by large real estate and resort development companies with the requisite knowledge and investment money. This is because selling property for fractional ownership requires time, money, and expertise that many private property owners, especially owners of a single property, do not have. Buyers of fractional ownership properties tend to require a high quality property in good condition, as well as a comprehensive operating and properly formed legal ownership structure. This makes it unlikely that a buyer will purchase a share of a private, non-professionally organized fractional ownership property, as he or she will see it as unduly risky, as well as not as desirable as a solely owned second home or vacation property.

To sell a property for fractional ownership, there are many issues to consider and tasks to complete. It is important to determine the property's viability and suitability for fractional ownership, as not all properties can successfully or legally be sold for fractional ownership. This may include analyzing local market conditions, such as other fractional or timeshare ownership competition in the area and the variety of alternatives to owning a second home within the market. Local zoning ordinances and other legal compliance requirements must also be evaluated, along with obtaining any state and local permits, or approvals that may be required. Further, the property may have existing covenants, conditions, and restrictions (CC&R's) that must be reviewed to evaluate possible violations with fractional ownership or use. General neighborhood and community concerns should also be considered before attempting to sell a home for fractional ownership.

Another important factor to determine is the number of shares, or interests to be sold in the property. The optimum number of fractional owners for a particular property may be more or less, and depend on a multitude of factors. Successfully selling the property for fractional ownership and obtaining the highest sales price for the property depends on not only the number of fractional ownership interests offered, but also the price that each buyer pays, or is willing to pay, for his or her share. In some cases it might be desirable to “divide” the property into six interests, with each owner receiving the right to use the property for up to two months per calendar year; with other properties it may make more sense to sell twelve fractional interests with a proportionate allocation of floating usage time, or even for a fixed period or periods, such as an entire month, for the same usage segment every year.

How the property is presented to a potential buyer can have a substantial impact on the overall success of the project and the overall sales price. A higher sales price can be achieved by the appearance and condition of the property itself, as well as by a professional sales approach that reassures the buyer of the competency of the organization behind the fractionalization of the property. The property's condition must be evaluated and, if required, new decorations, furnishings, modifications, improvements, or repairs may be required to professionally prepare the property before commencing a marketing, promotion and sales effort. In certain cases a professional decorator or designer may be employed to help in this process. A unique name may be given along with a logo to brand the property to enhance its market appeal and prestige. Professional quality photographs of the property and the surrounding area and amenities should be obtained. A video presentation or tour may also be helpful. To reach buyers, one must prepare marketing, advertising, promotional material, and a sales plan. These can include: MLS and other electronic listing service advertising, direct mail, email marketing, personal networking, property open house events, private property tours, cross-promotion with other area fractional ownership projects, media and news releases, hosted sales events, area real estate broker or agent open houses, open house and other signage, creating and hosting a website or featuring the property on an existing website devoted to the property or the selling of similarly structured properties, and internet advertising.

Along with promoting the property, the seller must evaluate and choose the appropriate fractional ownership structure for the property. During this stage, it might be helpful to also obtain legal counsel experienced in the field of timeshare and fractional ownership development and sales to provide, or to modify, an existing package of appropriate fractional ownership legal documents. A comprehensive and integrated legal document package must be developed or modified, which may include the rules and regulations for the co-ownership and use of the property, Articles of Incorporation of a new homeowners association or the formation of a limited liability company (LLC), corporation, or other entity to provide the common ownership of the property, a declaration of CC&R's for the homeowners association, corporation bylaws, Department of Real Estate or its equivalent applications for registration, permits, approvals and any other required state clearances, a buyer's reservation agreement for each fractional interest, a purchase and sale agreement for each fractional interest, a bill of sale for all personal property to be transferred with the property, the appropriate grant deed for each fractional interest, the appropriate legal disclosures for the sale of each fractional interest and the project, property management agreements, reservation management agreements, and concierge service agreements.

Even though the property may be properly advertised and all the necessary legal requirements have been met, there may be additional action required by the seller to more effectively sell the property. An owner's usage reservation and scheduling system should be developed to assist the new owners in conveniently choosing, assigning, or resolving, which time periods will be used by which owner. To assist buyers, it would be beneficial to first identify lenders able to finance individual buyer's mortgages of fractional interests in property, and to obtain those one or more lender's approval of the proposed project. Identifying appropriate comprehensive property and liability insurance for the fractional ownership property before the close of any escrows and a change of ownership. Preparing ongoing operating budgets and management guidelines, identification of appropriate service providers, approval of the local homeowner's or neighborhood association, if any, as well as negotiating future contracts for the maintenance, property management, reservation management and possible concierge services, are all items that should be resolved before commencing marketing of the project, to show future buyers that the seller has thought through and fully prepared an appropriate program for fractional ownership. The seller should also consider, and evaluate placing the property into an appropriate exchange program as an added benefit to the buyers.

During the actual selling process, the seller, or seller's listing broker will be required to resource, identify and develop qualified prospective buyers. Further, the seller, or seller's listing broker, will have to negotiate each buyer's reservation, purchase and sale agreements, or both, and manage and direct the escrow of each buyer.

Performing all of the tasks necessary to sell a property for fractional ownership can require an extensive amount of upfront time, money, know-how and expertise. These requirements make it virtually impossible for an individual, private property owner to efficiently and affordably sell his or her property for fractional ownership in a timely manner. This effectively gives large development companies an exclusive and uncompetitive market in selling fractional ownerships, which results in limited choices and higher prices for buyers due to the lack of competition. It also results in very few private single-family attached or detached homes being made available or sold for fractional ownership, forcing potential fractional buyers to purchase a share of a large complex, or project, with little real pride of ownership, if they want to purchase a fractional interest.

Many private property sellers and their listing brokers have unsuccessfully attempted to sell their properties fractionally, lacking the appropriate knowledge, materials, or expertise to properly prepare, market and sell a fractional ownership project. The seller may have difficulties even if he or she enlists the help of otherwise qualified real estate experts. Real estate brokers are typically not capable of providing all the services necessary to sell a home for fractional ownership. Therefore, the seller will have to search out additional experts at additional upfront costs, such as experts familiar with interior design, home renovation, preparation of the complex package of legal documents required for fractional ownership and property transactions, state and local zoning regulations and issues, homeowners association compliance issues and negotiation, fractional ownership financing and those specialized lender sources, insurance providers able to provide coverage for this specialty form of ownership; and marketing, promotion, and sales experts. The time required to source, identify, qualify and negotiate with each of these experts, as well as the combined costs, is in addition to the time and energy that the seller himself or herself must put into the project to successfully sell the property for fractional ownership. This can take many months to completely assemble all of the parties and experts, while the seller's property remains unsold, or off the market, pending this preparation and launch of the fractional ownership project.

The prior art has examples of selling property for fractional ownership, from real property to personal property. There are also various specialized individuals, associations, books and help aids that can assist owners in tackling the steps necessary for selling their property for fractional ownership. However, there is no single method or process that identifies a property that is appropriate for fractional ownership and then provides all the necessary know-how, documents and other resources to sell a property, risk-free, for fractional ownership, with little to no up-front cost or delay to the owner. The risk-free aspect of the current invention is extremely important, as a potential seller is much more likely to explore fractional sales if he or she does not have any upfront costs or expense.

Thus there has existed a long-felt need for a method for selling property for fractional ownership where the owner needs no special expertise in the field, or significant upfront investment. There is a need for a turnkey process that provides the owner of the property with a low-risk alternative to selling his or her property for sole ownership to a single buyer. The desired method should have little to no up-front costs to the owner, and all the necessary know-how, expertise, legal documents, branded and professional management, and resources should be provided. The owner should benefit from a higher sales price than he or she would otherwise be able to obtain, and the provider of the method is compensated from a portion of the increased sales price.

The current invention provides just such a solution by providing a method for assisting property owners in selling property for fractional ownership by locating a property that is already listed for sale and is a qualified candidate property, contacting the listing broker or owner about selling the property fractionally, offering the property for sale for fractional ownership concurrently with offering the property for sale for sole ownership, finding fractional buyers collectively willing to purchase the property for more than it could be sold to a single owner, assisting in the preparation and execution of all necessary documents required for the transactions, overseeing the sales transaction, and obtaining a commission or fee on the sale of the property concurrently with or separate from the listing broker. This creates a turnkey service to property owners interested in selling their property for fractional ownership without any increased risk and little to no upfront cost to the property owner.

There has thus been outlined, rather broadly, the more important features of the invention in order that the detailed description thereof may be better understood, and in order that the present contribution to the art may be better appreciated. There are additional features of the invention that will be described hereinafter and which will form the subject matter of the claims appended hereto. The features listed herein and other features, aspects and advantages of the present invention will become better understood with reference to the following description and appended claims. The accompanying drawings, which are incorporated in and constitute part of this specification, illustrate embodiments of the invention and, together with the description, serve to explain the principles of the invention.

Throughout this document, previously and hereinafter: the term “listing broker” is meant to encompass both licensed and non-licensed brokers or agents who list property for sale in a representative capacity for another; the term “fractional ownership” or like phrases shall be defined as any incidence of ownership in property with the right to use or occupy the property on some periodic basis, where fractional ownership may comprise a portion or all of the property and may include any time-share estate, interval ownership, right to revolving use of the property, vacation license, vacation lease, club membership, time-share use, or uses of a similar nature; the term “property” shall include real and personal property, where personal property may include aircraft, water-going vessels, motor vehicles, and jewelry; the terms “individual,” “individuals,” “person,” and “persons,” are meant to include one or more real individuals, legal entities, or both; the term “assistance” with regard to some action or object is meant to include any step to aid the user in performing some action or obtaining some object, and specifically may include the preparation, creation, and provision of any documents; and the term “seller” shall be defined as the original owner of the property that is being offered for sale.

### SUMMARY OF THE INVENTION

The current invention is a turnkey method for selling property for fractional ownership. First, the user of the invention identifies an existing property that is a good candidate for fractional ownership. The user contacts the owner, directly or indirectly through the owner's listing broker, about providing a service to sell the property for fractional ownership. If the owner agrees, the user contracts with the owner, the listing broker, or both to provide turnkey consulting services to prepare the property for sale as a fractional ownership property, and to oversee all of the stages of the marketing, promotion and sale of the property in exchange for an optimally contingent consulting, or broker fee. Alternately, an owner, or the owner's listing broker contacts the user of the invention to present their property for consideration as a fractional ownership property, which if the user agrees is a candidate and is willing to provide his or her turnkey services to the owner or listing broker of the property, then contracts with the owner, the listing broker, or both to provide turnkey consulting services to prepare the property for sale as a fractional ownership property, and to oversee all of the stages of the marketing, promotion and sale of the property in exchange for an optimally contingent consulting or broker fee.

Once under contract with the owner, the listing broker, or both, the user provides or assists the owner and the listing broker in developing or performing all or any number of the following, all of which may be performed in any order: analysis of local market conditions; area competition and vacation home ownership alternatives; evaluation of zoning issues and requirements for the fractional ownership property; evaluation of neighborhood concerns for the fractional ownership property; evaluation of the appropriate number of interests and the pricing schedule for each share of the fractional ownership property; evaluation of the present property condition and making of recommendations for the appropriate decoration, furnishings, modifications, improvements and repairs to make to the property; development of the fractional ownership property name and a logo to brand the property; development of a marketing, promotion, advertising, and sales plan for the sale of the interests in the fractional ownership property; development and preparation of all marketing and sales materials for the fractional ownership property; placement of advertising in print, electronic, and internet media for the marketing and sale of the fractional ownership property; management of the promotion and sale of the interests in the fractional ownership property; provision of signage for use in open house events at the property; assistance with the development of documents necessary for the ongoing operation of the fractional ownership property, including the establishment of a homeowners association (HOA), rules & regulations, bylaws, operating budgets, reservation and property usage policy, maintenance plan, property management, and property and liability insurance coverage; assistance with the identification of issues regarding possible violations of and compliance with any existing property CC&R's as a result of the planned fractional ownership property; assistance with the identification of and obtaining of the appropriate state and local government permits for the fractional ownership property; assistance with the preparation of all the necessary legal documents for the sale of the property for fractional ownership including some or all of the following: i) comprehensive rules and regulations for use of the property, ii) Articles of Incorporation for any HOA, LLC, or any other appropriate legal entity structure, in certain jurisdictions, iii) declaration of CC&R's, iv) bylaws of the association or legal entity, v) Department of Real Estate, or its equivalent, applications for registration of or clearance for the project, vi) permits or clearance documents, or both, vii) fractional interest buyer reservation agreement, vii) fractional interest purchase and sale agreement, viii) bill of sale for all personal property to be transferred with the property, ix) fractional interest grant deed, or its equivalent for ownership in a legal entity that will own the fractional ownership property, x) appropriate legal disclosures for the sale of fractional ownership interests in the fractional ownership property, xi) property management agreement, and xii) owner reservation and scheduling system in the fractional ownership property; assistance in the negotiation of all reservation, purchase and sale agreements, or both for sale of the interests in the fractional ownership property; assistance in managing all escrows and sales of the interests in the fractional ownership property; assistance in sourcing appropriate mortgage lenders and arranging for one or more buyers' financing of the interests in the fractional ownership property; assistance in securing a quote for the appropriate property and liability insurance coverage policy for the fractional ownership property; assistance in the preparation of annual operating budgets for the fractional ownership property; assistance with the selection and contracting of local maintenance services for the fractional ownership property; assistance in the placement, or inclusion of the fractional ownership property in an exchange program; and training and coaching of the owner, the listing broker, or both on the marketing, sale, and legal aspects of the fractional ownership property.

Next, the property is offered for sale for fractional ownership while simultaneously being offered for sale for sole ownership to a single buyer; thus, there is virtually no risk to the seller as he or she does not need to take the property off the market to also explore the possibility of selling it as a fractional ownership property. The user of the invention assists the owner in finding and arranging for the appropriate number of buyers for the fractional ownership sale. The user then oversees the final sales transactions. Benefiting from this invention, the owner can obtain a higher sales price for his or her property than would otherwise be obtainable through a normal sale of the entire property. The user benefits by taking a portion of the increased sales price. The listing broker who originally listed the property can also be additionally compensated for his or her services, and will benefit from the higher total sales price of the property, as listing brokers are traditionally paid a percentage of the sales price.

The following Table 1 is an example of the difference between selling the property conventionally for sole ownership property to a single buyer and selling the property for fractional ownership to several buyers. Actual percentages and dollar values will vary from property to property as each sale is negotiated separately with different individuals. One of the key points to the current invention is the lower fractional sales price markup as compared to other systems for selling property for fractional ownership. Previously, owners selling their property for fractional ownership marked up the value of the property an average of 80%, partially because of the larger upfront marketing, advertising, sales and legal expenses, as well as acquisition costs and development risks, associated with buying and selling a property for fractional ownership. The current method, however, can sell a property for fractional ownership with a lower fractional markup of the fractional interests to the buyers, while still providing the owner with a significant increase in the net sales price that he or she would otherwise not have been able to obtain. The lower markup also has added benefits of attracting more potential buyers, especially when compared to the pricing of other property currently being sold for fractional ownership.

TABLE 1
Property Sale Comparison
Proceeds from Fractional Sale

| | |
|---|---|
| Underlying Property Value | $1,000,000 |
| Fractional Ownership Markup | 30% |
| Fractionalized Sale Value | $1,300,000 |
| Number of Fractional Interests Sold | 8 |
| Price Per Fractional Interest | $162,500 |
| Total Sale | $1,300,000 |
| Consulting Fee to User (10%) | $130,000 |
| Gross Proceeds to Seller | $1,170,000 |
| Commission to Listing Broker (5%) | $65,000 |
| Net Proceeds to Seller | $1,105,000 |

Proceeds from Conventional Single Buyer Sale

| | |
|---|---|
| List Price | $1,000,000 |
| Negotiated Sale Price (5% Reduction) | $950,000 |
| Commission to Listing Broker (5%) | $47,500 |
| Net Proceeds to Seller | $902,500 |

Sales Proceeds Comparison

| | |
|---|---|
| Additional Fractional Sales Profit to Seller | $202,500 |
| Percent of Net Additional Profit | 22% |

It is a principal object of the invention to provide a method for selling property for fractional ownership that is a virtually risk-free alternative for the owner of the property.

It is another object of the invention to provide a method for selling property for fractional ownership that includes little to no up-front costs to the property owner.

It is an additional object of this invention to provide a method for selling property for fractional ownership that is a turnkey service to the property owner, where all the necessary know-how, materials, and documents are made available to the property owner.

It is a further object of this invention to provide a method for selling property for fractional ownership where the owner is not required to have any expertise in the field, or to seek out the multiple experts needed to collectively provide a turnkey service to sell his or her property for fractional ownership.

It is yet another object of the invention to provide a method for selling property for fractional ownership where the user gets compensated for his or her services primarily on a contingent basis.

It is an additional object of this invention to provide a method for selling property for fractional ownership where the listing broker of the property can be additionally compensated for his or her services.

It is a final object of this invention to provide a method for selling property for fractional ownership that obtains a higher net sales price for the property than the owner would otherwise have been able to obtain.

It should be understood that while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention. Specifically, the method of this invention is set forth in its preferred embodiment, but other embodiments can utilize only some of the steps and actions as described herein.

### BRIEF DESCRIPTION OF THE FIGURES

FIG. 1 is a flow chart of the major steps associated with the current method for selling a property for fractional ownership.

FIG. 2 is a diagram of one embodiment of the financial and contractual relationships between the various parties associated with selling property for fractional ownership.

FIG. 3 is a diagram of another embodiment of the financial and contractual relationships between the various parties associated with selling property for fractional ownership.

### DETAILED DESCRIPTION OF THE FIGURES

Many aspects of the invention can be better understood with reference to the drawings below. The components in the drawings are not necessarily drawn to scale. Instead, emphasis is placed upon clearly illustrating the components of the present invention. Moreover, like reference numerals designate corresponding parts through the several views in the drawings. The user of the invention will generally be a consultant, where the consultant uses the current method of the invention to render services to existing property owners. As stated previously, preferred embodiments of the invention are illustrated in the figures, but it is intended that other combinations of the elements described in this patent application may be utilized by users of the invention, and that these combinations are also claimed as part of this invention.

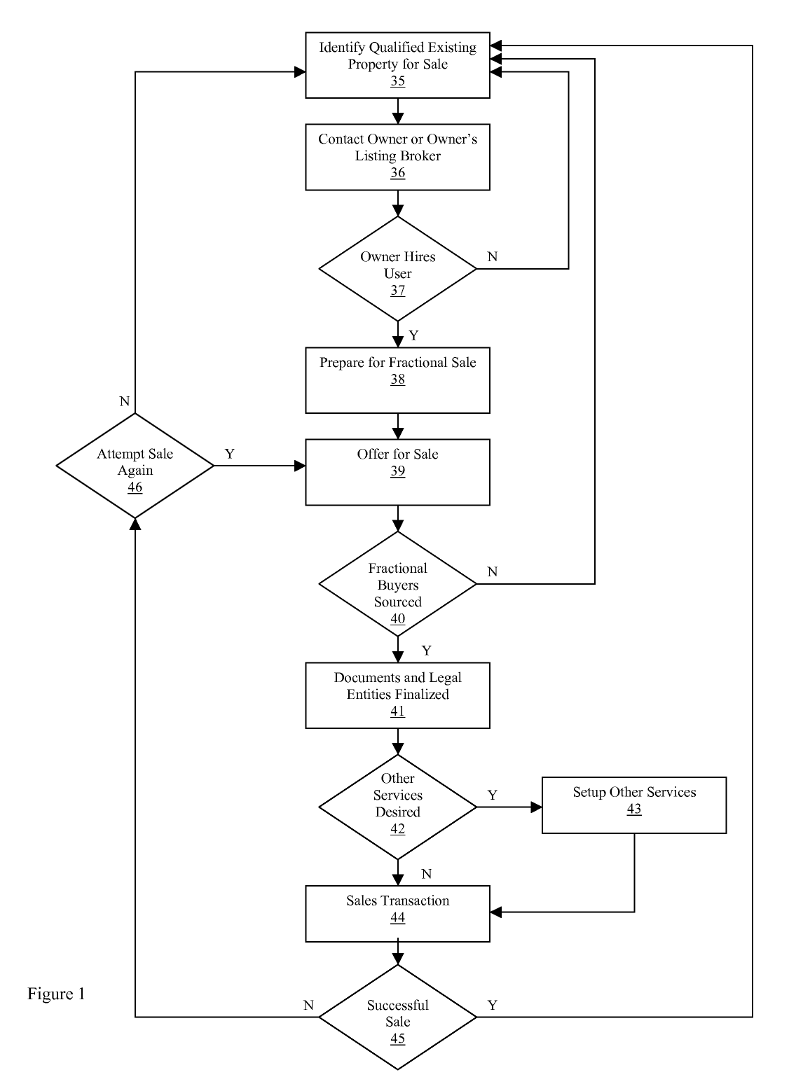

FIG. 1 is a flow chart of the major steps associated with the current method for selling a property for fractional ownership. The first step is to identify a qualified existing property for sale 35, or a property that will be offered for sale in the near future, where the user locates or is presented an existing property that is a qualified candidate for fractional ownership. In this step, the user can search known real estate listing services and databases, such as MLS, simply drive through a desirable neighborhood to look for candidate properties that are currently on the market, or search other advertising materials that list property, real or personal, for sale. Candidate fractional ownership homes, for example, might be searched for in resort, tourist, or second home vacation market areas, including popular ski, beach, lake, golf, country, and urban areas. The properties found through this search are generally already listed with a listing broker, thereby confirming that the property is for sale. Alternatively, the property could be listed for sale by the owner, or under construction for sale. The various listing services typically provide important property information, including general descriptive property information and photographs of the architectural appeal, age, size, number of bedrooms, number of bathrooms, furnishings, condition, amenities, features, listing broker information, historic sales information, asking price and other marketing information, that allows the user to better evaluate whether the particular property is a good candidate for fractional ownership.

Once the user of the invention has ascertained a qualified candidate property, he or she will contact the owner or owner's listing broker 36, preferably through the owner's representative, or listing broker, associated with the property, or the owner directly if the property is for sale by owner. During the initial contact, the user will propose the idea of selling the property for fractional ownership. The user outlines the concept of fractional ownership, the benefits to the owner to sell his or her property for fractional ownership, and why the user believes that the owner's property is a qualified candidate for fractional ownership. The user offers his or her services as an expert in the field with a turnkey service to sell the property for fractional ownership. While the services performed by the user can be offered and provided directly to the owner, it can be beneficial for the user to work with the listing broker to collectively provide the services required to sell the property for fractional ownership. A unique feature of the invention is that the listing broker or owner can continue to offer the property for sale as originally planned while the property is simultaneously offered for sale for fractional ownership property. This creates a no-added-risk sale situation for the owner; if selling for fractional ownership is later determined not to be feasible or beneficial, the owner will not lose marketing time or money since the property is concurrently for sale as a sole ownership property to a single buyer with the listing broker. Empowered with this information, the listing broker, the user, or both can approach the owner of the property to present and offer a turnkey, no-risk service of selling the property for fractional ownership.

At this point, the owner hires user 37 to perform his or her services and program, or elects not to. If the owner rejects the proposal of selling the property for fractional ownership, then the user can return to the initial step and identify a qualified existing property for sale 35. On the other hand, the owner can choose to sell the property for fractional ownership and proceed with hiring the user to provide his or her services and program. In this embodiment, the owner contracts directly with the user for the services and program. Alternatively, the user may contract with the listing broker, and the user and listing broker collectively provide the services and program to the owner on a shared fee basis, either under the existing agreement between the listing broker and owner or under a new or revised agreement.

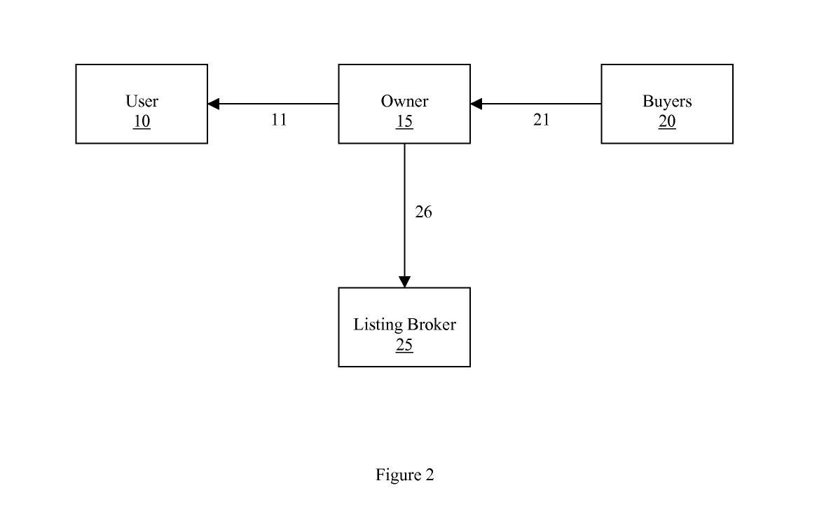

Various means for compensating the user and listing broker can be used. FIG. 2 is a diagram of one embodiment of the financial and contractual relationships between the various parties associated with selling the property for fractional ownership. In this simple relationship, the user 10 contracts directly with the owner 15. Under this agreement, the user 10 might choose to receive a user commission 11 of the final sales price of the home assuming the home is sold for fractional ownership using the user's services and turnkey program. A preferred percentage for the user commission 11 that the user 10 might accept for his or her services is 10% of the collective sale price for all fractional ownership interests. Alternatively, the user commission 11 could be a set fee regardless of the final sale price. Additionally, the owner 15 can be under a contractual relationship with the listing broker 25, where the listing broker receives a listing broker commission 26 for the sale of the home. This listing broker commission 26 could be, for example, 5%. Under the contract between the owner 15 and the listing broker 25, the listing broker 25 might be entitled to the listing broker commission 26 if the home is sold conventionally to a single buyer, and an additional amount of commission 26 if the home is sold for fractional ownership. The buyers 20 pay the purchase price 21 of the combined fractional interests in the property to the owner 15, who then pays the listing broker commission 26 to the listing broker 25 and the user commission 11 to the user 10. Further, in this embodiment, no independent outside attorney is required. This could be because the user is a qualified attorney, the listing broker is a qualified attorney, or the user is an attorney or knows of a qualified attorney who is willing to perform his or her services for free.

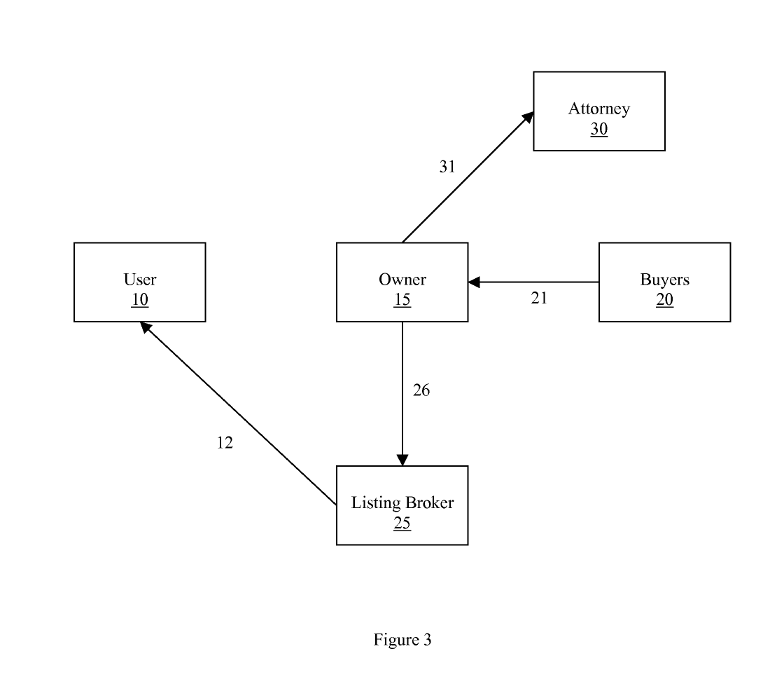

An alternative financial arrangement can be found in FIG. 3. FIG. 3 is a diagram of another embodiment of the financial and contractual relationships between the various parties associated with selling property for fractional ownership. In this relationship, the owner 10 contracts directly with the listing broker 25. The listing broker 25 then teams up under a separate contract with the user 10 to provide services, selling the property as a sole ownership to a single buyer, and selling the property for fractional ownership at the same time, and the listing broker 25 receives a listing broker commission 26 that is larger than if he or she was only providing one of the services. Under this arrangement, a preferred percentage for the listing broker commission 26 is 15%. The listing broker 25 contracts with the user 10, where the user 10 assists the listing broker 25 in selling the property for fractional ownership. In exchange for the user's assistance, the user 10 can receive a user commission 11 from the listing broker 25 if the property sells for fractional ownership. The user commission 11 can be calculated in various ways, including as a percentage of the listing broker's commission 26, a percentage of the cumulative sale of the property, or as a fixed fee. The buyers 20 pay the purchase price 21 of the property to the owner 15, who then pays the listing broker commission 26 to the listing broker 25. The listing broker 25 in turn pays the user commission 11 to the user 10. Further, in this embodiment, the owner 15 uses an independent outside attorney 30, possibly recommended by the user 10, to prepare the documents related to the sale of the property for fractional ownership. In this scenario, the owner 15 would pay fees 31 directly to the attorney 30. The fees 31 could also be proportional to the cumulative sales price or fixed.

Various other financial arrangements between the owner, user, and listing broker are possible, without deviating from the scope of the invention. One such possibility is that the listing broker receives a listing broker commission from the user, and the user collects a larger user commission from the owner. It is also possible to combine the various relationships such that the user may be compensated from both the owner and the listing broker, or the listing broker is compensated from both the owner and the user, or the user is also the listing broker directly providing both services to the owner, or the user teams up with an attorney to mutually provide the turnkey services to either the owner or the listing broker, or both. In another alternative, the consultant provides services on an a la carte basis, where different services are provided for a fixed fee based on the services actually provided. In addition to the commissions and fees that the owner pays, the owner may be required to directly pay certain fees and expenses or reimbursements for certain costs incurred in the preparation and development of the fractional sale, such as new furnishings, decorations, repairs or modifications to the property, applications for permit or registration, and fees to an attorney. These expenses, however, are often required for any sale of a property, regardless of whether it is for sole ownership or fractional ownership. These fees can be subtracted before or after the commissions for the various parties are calculated. However, to maintain a no-risk, no upfront cost to the owner, it is suggested that the owner only be required to pay any fees or expenses if the sale of the property for fractional ownership is completed. As a means to reduce risk to the owner, the owner may delay the hiring of an attorney to prepare the final documents for the sale of the fractional ownership property until the owner has received a substantial number of reservations from buyers for the fractional interests.

Returning to FIG. 1, once the owner hires user 37 and all relevant contractual and financial relationships have been formed, the user 10 provides the owner with a turnkey program to sell the property for fractional ownership, and will assist the owner in preparing for fractional sale 38. This can include advice for or services of marketing, advertising, promotion, decorating, furnishing, financial, insurance market evaluation, property management, reservation and concierge management, and legal issues and assistance in all documentation. The user can also provide sample or final legal documents, sample forms for the fractional sale, sample forms for the ownership and management of the property as fractional ownership, business advice on formulas, plans, usage schedules, reservation systems, methods, historic and market information, prospective leads to the owner, listing broker, or both, and integration with a network of other fractional or timeshare ownership projects. At this stage, the target number of fractional owners should be determined, along with appropriate overall markup of the underlying value of the property. These numbers should be used to determine the optimum sale price per fractional interest. The actual percentage amount of overall markup, number of, and price per fractional interest should be determined separately for each property, as each property is unique with different market, zoning, regulations, restrictions, desirable features and amenities, and market conditions that can lead to different per fractional interest and cumulative sales prices for each the property.

Once the step of preparing for fractional sale 38 has been completed, the property can be offered for sale 39 for fractional ownership. This can be done concurrently with selling the property traditionally to another single buyer. Here, the user and listing broker work together in marketing, promotion, negotiation, and sale of the fractional ownership interests to prospective buyers. The user may simply be used as a consultant by the listing broker and owner, offering advice to the listing broker or owner when requested, or alternatively take a more active role in the selling of the property for fractional ownership. Preferably, the potential buyers of the property should negotiate the purchase of their respective fractional interests in the property through the listing broker. However, the user, the owner, or another representative of the owner could handle these negotiations.

At a certain point in time, there will either be a sufficient number of fractional buyers to proceed with the sale of the property for fractional ownership, or the property will be sold as a whole to a single buyer. If a sufficient number of fractional buyers are sourced 40, then the process will continue where the documents and legal entities are finalized 41. On the other hand, if no fractional buyers are sourced 40, or an insufficient number of fractional buyers are sourced before the property is sold to another buyer, then the user ends the process with this property and returns to the initial step to identify a qualified existing property for sale 35. Assuming there are a sufficient number of buyers interested in fractional ownership of the property, each fractional interest should then be contracted for between the seller (owner) and the prospective buyers.

After fractional buyers are found 40, necessary documents and legal entities are finalized 41. This includes a legal document package that contains a purchase and sale agreement, and other related and integrated documents. The user may introduce the owner to a qualified attorney, licensed to practice law in the particular state or district where the property resides. Alternatively, the owner himself or herself may have an attorney who is ready, willing, and able to offer the required legal advice, review appropriate legal forms, documents, formulas, plans, schedules, systems, and methods for the proposed sale of the property for fractional ownership. The attorney may also be required to evaluate local zoning ordinances, government compliance requirements or violations of any homeowners association CC&R's, or any other legal issues relevant to the sale of the property for fractional ownership. Another possibility is that the user himself or herself may be a licensed attorney that is ready, willing, and able to perform any requisite services outlined above.

There are various means by which the fractional co-owners can own the property. One such vehicle is that each buyer will own a certain portion of the property directly, in fee, such as by forming a tenancy-in-common ownership in the property. Another possible vehicle is to own the property through a legal entity, where each buyer will own a portion of the legal entity, and the legal entity owns the entire property. For example, the property could be sold to an LLC, where the LLC is the sole owner of the property, and multiple members own the LLC, where each member interest is comparable to a fractional interest in the property. Each member of the LLC would then have the right of exclusive use of the property for a fraction of the year. This creates a fractional ownership of the property notwithstanding the legal entity that is between the property and the owners. Another possible vehicle is for fractional co-ownership of the property in fee, or through a legal entity such as an LLC, without a right of use of the property coupled with the purchase, and where the co-owners or members of the LLC rent the property from each other for their respective periodic use. There are other various means and legal entities for multiple buyers to own a single piece of property that can be used without departing from the scope of this invention.

There may come a point in the process where other services are desired 42. If other services are desired 42, then the user can setup other services 43. Alternatively, the user can assist the owner or listing broker with the setup of other services 43. The combination of the various embodiments of the invention as described earlier with various additional services are considered alternative embodiments of the invention. The setup of other services 43 can include the selection and contracting of qualified property management, reservation management, concierge or support services for the fractional co-owners. Another possible service is to identify and secure insurance for the property for the fractional co-owners. Further, assisting fractional buyers in obtaining mortgage financing for their respective fractional interests is another service. Additional services could also include the development or acquisition of a co-owner's usage reservation and scheduling system or method and the evaluation and placement of the property into an appropriate reciprocal vacation property exchange program. Ongoing cleaning and maintenance services may also be required. Various other services may be necessary or beneficial to the proper or successful sale of the property for fractional ownership.

Regardless of whether other services are desired 42, the user should oversee the sales transaction 44. During the sale of the property for fractional ownership, an escrow account should be opened for each purchase and sale agreement of the property, as and when each interest in the property is purchased. The user, the listing broker, or preferably both, should oversee these escrow accounts, along with the progress of the transaction, until closing, cancellation, or termination. The user, along with the listing broker, should make arrangements for payment of their respective commissions, if applicable, from the proceeds of the sale of the property.

If there was a successful sale 45 of all or a portion of the fractional interests in the property for fractional ownership, then the process is complete, and the user may start the process again by locating a qualified existing home for sale 35. If there was not a successful sale 45, or only a portion of the fractional interests were sold, then the user, listing broker, and owner can agree to continue the process and attempt the sale again 46 of any remaining, or all fractional interests, in which case the property is once again offered for sale as a fractional ownership. If the user, listing broker, or owner do not want to attempt the sale again, then the process has ended, and the user can begin the process again by identifying a qualified existing property for sale 35. It is also possible that less than the total number of shares required to complete the entire fractional sale are actually sold. In this situation, one or more interests in the property have been sold, but the requisite number of buyers has not been sourced to complete the sale of the entire property. Therefore, the owner retains a certain percentage of the ownership in the property as if he or she was one of the fractional owners. The owner may continue to sell his or her remaining interest in the property, or be content with the amount sold and retain some ownership of the property through fractional ownership.

The basic steps outlined above are in a preferred order, but deviations from the order are possible without deviating from the scope and goal of the current invention. During certain situations, it may be more beneficial to setup other services desired 42 earlier in the process, such as before fractional buyers are sourced 40. This may be helpful to entice prospective buyers with a list of such other services. Further, it may be beneficial to have the documents and legal entities 41 finalized before all of the fractional buyers are sourced 40. If the parties attempt the sale again 46, then some of the previous fractional buyers may still be interested in purchasing the property, and these buyers may be sufficient to continue with another sales transaction 44 without to the need locate additional buyers.

The current invention can have multiple users, or a primary user with one or more sub or associate users under his or her direction, most likely when the sub or associate user is more knowledgeable and experienced in a geographic location, or more closely located in the general area of the property, and assists the primary user in performing the hands-on portions of the method outlined above. In this scenario, both users would share in the commissions or fees paid for their services by the owner.

It is possible that the owner of the property, the listing broker, or both may choose to cancel any agreements they have with the user and no longer use the services of the user, even during the preparation or sale of the property. While the user may be entitled to a cancellation fee, the user should nonetheless begin the process again by identifying a qualified existing property for sale 35.

The cumulative sales price for the property as a fractional ownership property may, and preferably will be, less than the industry average. This is due to the fact that the property is already on the market and the owner does not have the typical acquisition costs and development risks as compared to a developer that purchases or builds a home for fractional sale and since the user is providing the turnkey services embodied by the current invention on a contingent basis. The lower markup makes purchasing fractional interests in property under this method more affordable and appealing to potential buyers, while at the same time creating an increased sales price that makes it beneficial for the owner as well.

Since the services provided by the user to the owner can include no-added-risk and no upfront costs, the services provided by the current invention can be very appealing to an owner wanting to sell his or her property at a higher price, but is unable or unwilling to enter into an exclusive contract to only offer his or her property for sale as a fractional ownership property, or to pay the significant up-front costs and put in the time required to prepare the property and all of the legal and marketing materials for fractional ownership sale on his or her own. The listing broker finds the services provided by the current invention appealing as well, due to the higher collective sales price of the property sold for fractional ownership, and therefore a higher commission, as well as being provided the opportunity and ability to sell a property for fractional ownership with the assistance and ability of the user. Further, with the current invention, the owner and the listing broker have an expanded market with which to sell the home to prospective buyers.

It is also important to note that various types of property may be sold using the method of the current invention. It can include real property, such as attached or detached homes, townhomes, condominiums, hotels, motels, lodges, sport venues such as parks, tracks, stadiums, and fields, mines, wells, farms, land, islands, campsites, or expensive personal property, such as aircraft, yachts, boats, submarines, personal watercraft, automobiles, motorcycles, motor homes, trains, space craft, or any other real or personal property that would benefit from fractional ownership and fractional use. Multiple real properties or personal property assets can also be sold at the same time to the same group of fractional buyers, or individually to different fractional buyers, or groups of fractional buyers.

What I claim is:

1. A method for selling property for fractional ownership comprising the steps of:
(1) identifying a property already listed for sale or being offered for sale in the near future that is a qualified candidate for fractional ownership, where the property is identified actively or passively, where actively identifying the property comprises locating the property, where passively identifying the property comprises being presented the property,
(2) contacting the owner and proposing that the owner offer the property for sale for fractional ownership and offering the owner a service that comprises the provision of necessary expertise, skill, and products to sell the owner's property for fractional ownership,
(3) if the owner agrees to offer the property for sale as a fractional ownership and use the offered service, providing the owner with the service,
where the owner is contacted directly or indirectly, where the owner is contacted through a representative of the owner when contacted indirectly, where the owner, when contacted, is informed, directly or indirectly, of the service that will be provided to sell the property for fractional ownership,
where the property can comprise of one or more individual properties of similar or different type,
where the owner is not required to have any expertise or experience in the field of fractional ownership or sales, and
where fractional ownership comprises of two or more persons, known as fractional owners, directly or indirectly co-owning property coupled with each fractional owner having a right to use the property a portion of the total available time.

2. The method of claim 1, where, as a part of the service, two or more buyers are sourced and enter into a contract to purchase a fractional interest in the property.

3. The method of claim 1, where the service that will be provided to sell the owner's property for fractional ownership further comprises one or more services selected from the group comprising: sourcing insurance for the property, sourcing mortgage financing for potential buyers of the property, obtaining a reservation and scheduling system or method, preparing ongoing operating budgets and management guidelines, placing the property into an appropriate reciprocal vacation property exchange program, and obtaining ongoing property management services.

4. The method of claim 1, where the property is offered for sale for fractional ownership concurrently with offering the property for sale for whole ownership.

5. The method of claim 1, where the necessary products to sell the owner's property for fractional ownership comprise purchase and sale agreements.

6. The method of claim 1, where the necessary products to sell the owner's property for fractional ownership comprise covenants, conditions, and restrictions.

7. The method of claim 1, where the service that will be provided to sell the owner's property for fractional ownership further comprises one or more services selected from the group comprising: marketing, advertising, promotion, decorating, and furnishing.

8. The method of claim 1, where the service that will be provided to sell the owner's property for fractional ownership further comprises one or more services selected from the group comprising: financial advice, evaluation of relevant market and legal issues, and business advice.

9. The method of claim 1, where the service that will be provided to sell the owner's property for fractional ownership further comprises introducing the property into an exchange network of other fractional or timeshare properties.

10. The method of claim 1, where the fractional owners have exclusive use of the property on a recurring basis over a period of time.

11. The method of claim 1, where the total available time is one or more years.

12. A method for selling property for fractional ownership comprising the steps of:
(1) identifying a property already listed for sale or being offered for sale in the near future that is a qualified candidate for fractional ownership, where the property is identified actively or passively, where actively identifying the property comprises locating the property, where passively identifying the property comprises being presented the property,
(2) contacting the owner and proposing that the owner offer the property for sale for fractional ownership and offering the owner a service that comprises the provision of necessary expertise, skill, and products to sell the owner's property for fractional ownership,
(3) if the owner agrees to offer the property for sale as a fractional ownership and use the offered service, providing the owner with the service which comprises the steps of
(a) assisting the owner in preparing the property for sale for fractional ownership,
(b) offering the property for sale for fractional ownership,
(c) locating and arranging for two or more buyers to enter into purchase agreements to purchase an interest in the property as fractional owners thereby starting a sales transaction,
(d) overseeing the sales transaction of the property through to closing, cancellation, or termination of the purchase agreements, and,
(e) receiving compensation from the owner, directly or indirectly, as a result of the sale of the property for fractional ownership,
where any documents, legal entities, or both necessary to sell the property for fractional ownership are prepared and finalized anytime before the sales transaction closes,
where the owner is contacted directly or indirectly, where the owner is contacted through a representative of the owner when contacted indirectly, where the owner, when contacted, is informed, directly or indirectly, of the service that will be provided to sell the property for fractional ownership,
where the property can comprise of one or more individual properties of similar or different type,
where the owner is not required to have any expertise or experience in the field of fractional ownership or sales, and
where fractional ownership comprises of two or more persons, known as fractional owners, directly or indirectly co-owning property coupled with each fractional owner having a right to use the property a portion of the total available time.

13. The method of claim 12, where the fractional owners have exclusive use of the property on a recurring basis over a period of time.

14. The method of claim 12, where the total available time is one or more years.

15. The method of claim 12, where additional services are provided after the owner agrees to offer the property for sale as a fractional ownership property and before the closing of any purchase transaction.

16. The method of claim 15, where the additional services comprise one or more services selected from the group comprising: sourcing insurance for the property, sourcing mortgage financing for potential buyers of the property, obtaining a reservation and scheduling system or method, preparing ongoing operating budgets and management guidelines, placing the property into an appropriate reciprocal vacation property exchange program, and obtaining ongoing property management services.

17. The method of claim 15, where the additional services comprise one or more services selected from the group comprising: marketing, advertising, promotion, decorating, and furnishing.

18. The method of claim 12, where the service that will be provided to sell the owner's property for fractional ownership further comprises one or more services selected from the group comprising: financial advice, evaluation of relevant market and legal issues, and business advice.

19. The method of claim 12, where the service that will be provided to sell the owner's property for fractional ownership further comprises introducing the property into an exchange network of other fractional or timeshare properties.

20. A method for selling property for fractional ownership comprising the steps of:
(1) identifying a property already listed for sale or being offered for sale in the near future that is a qualified candidate for fractional ownership, where the property is identified actively or passively, where actively identifying the property comprises locating the property, where passively identifying the property comprises being presented the property,
(2) contacting the owner and proposing that the owner offer the property for sale for fractional ownership and offering the owner a service that comprises the provision of necessary expertise, skill, and products to sell the owner's property for fractional ownership,
(3) if the owner agrees to offer the property for sale as a fractional ownership and use the offered service, providing the owner with the service which comprises the steps of
(a) assisting the owner in preparing the property for sale for fractional ownership,
(b) offering the property for sale for fractional ownership,
(c) locating and arranging for two or more buyers to enter into purchase agreements to purchase an interest in the property as fractional owners thereby starting a sales transaction,
(d) overseeing the sales transaction of the property through to closing, cancellation, or termination of the purchase agreements, and,
(e) receiving compensation from the owner, directly or indirectly, as a result of the sale of the property for fractional ownership,
where any documents, legal entities, or both necessary to sell the property for fractional ownership are prepared and finalized anytime before the sales transaction closes,
where one or more additional services are performed anytime before the close of the sales transaction, where the one or more additional services performed benefit the future fractional owners of the property,
where the owner is contacted directly or indirectly, where the owner is contacted through a representative of the owner when contacted indirectly, where the owner, when contacted, is informed, directly or indirectly, of the turnkey service that will be provided to sell the property for fractional ownership,
where the owner is not required to have any expertise or experience in the field of fractional ownership or sales,
where the property can comprise of one or more individual properties of similar or different type,
where fractional ownership comprises of two or more persons, known as fractional owners, directly or indirectly co-owning property coupled with each fractional owner having a right to use the property a portion of the total available time, and
where compensation received from the owner is related to the cumulative sale price of the property, where the cumulative sale price of the property is the total price paid for the property by all of the fractional owners.
